(19) United States
(12) Patent Application Publication
(10) Pub. No.: US 2025/0259133 A1
(43) Pub. Date: Aug. 14, 2025

(54) METHOD AND APPARATUS FOR PROCESSING AND SORTING SHIPMENTS

(71) Applicants: Robert Felline, Frankfurt am Main (DE); Angela Hausmann, Bonn (DE)

(72) Inventors: Robert Felline, Frankfurt am Main (DE); Angela Hausmann, Bonn (DE)

(73) Assignee: Deutsche Post AG, Bonn (DE)

(21) Appl. No.: 19/044,827

(22) Filed: Feb. 4, 2025

(30) Foreign Application Priority Data
Feb. 13, 2024 (DE) 10 2024 103 980.9

(51) Int. Cl. G06Q 10/083

(52) U.S. Cl. CPC G06Q 10/083

(57) ABSTRACT

Methods, apparatuses, systems, and computer programs for sorting and delivering shipments. The shipments are in particular shipments for which sorting in accordance with the delivery sequence is not possible.

### CROSS-REFERENCE TO RELATED PATENT APPLICATIONS

This patent application claims the benefit of priority to German Patent Application No. 10 2024 103 980.9 filed Feb. 13, 2024, the entire teachings and disclosures are incorporated herein by reference thereto.

### TECHNICAL FIELD

Exemplary embodiments of the invention relate to methods, apparatuses, systems, and computer programs for sorting and delivering shipments, wherein the shipments are in particular shipments for which sorting in accordance with the delivery sequence is not possible or is only possible with great effort.

### BACKGROUND

For delivery or supplier services, shipments are distributed in a manner allocated into distribution areas. Each distribution area has a distribution center in which the shipments are sorted according to the respective deliverers and for their delivery tours. Various shipment formats are processed separately in this case, such as standard letters, large letters, and non-machine-capable shipments, which cannot be sorted by a machine.

Automatically processable shipments are sorted in the sorting installations of the distribution center up to the trip order. The trip order corresponds here to the sequence in which the deliverer requires the shipments on their delivery tour.

Non-machine-capable shipments, such as those having unusual formats, or shipments which are not automatically processable for other reasons are initially sorted in the distribution center for the local shipment distribution locations, such as delivery bases or depots, then for the deliverers, and in a last step by the deliverer into the local shipment distribution location manually for the trip order.

### SUMMARY OF SEVERAL EXEMPLARY EMBODIMENTS OF THE INVENTION

With respect to the delivery process, it is desirable for the deliverer to be able to detect without great effort during the delivery which is the next shipment to be delivered and where this is located within their transport containers.

With respect to the processing in the distribution centers, it is desirable for shipments to be able to be processed directly after their arrival. In the known methods for sorting according to trip order in multiple sorting passes, the trip order sorting can first be performed when all shipments of a delivery tour are known in the distribution center. In the case of large amounts of shipments, it is possible that the existing sorting capacity in the distribution center is not sufficient to sort all shipments for trip order after arrival of the last shipment. Shipments arriving too late or shipments not taken into consideration due to the sorting capacity can only be sorted for trip order in the next sorting turn, for example, on the next day, or have to be transferred to the deliverer unsorted.

It is however desirable for the deliverer to be able to begin with the delivery as directly as possible, after they have received all shipments required for their delivery tour. The manual sorting of shipments, which are not automatically sorted in trip order, by the deliverer in the local shipment distribution location (for example, in the delivery base or depot) also means, in addition to the time loss, an additional space requirement in the local shipment distribution location, since a sorting area has to be available for each deliverer.

The present invention has the object of overcoming one or more of the above-described disadvantages and/or retaining one or more of the above-described advantages and/or achieving one or more of the above-described desired improvements.

According to a first exemplary aspect of the invention, a method is disclosed which is performed, for example, by a sorting installation (for example, in the distribution centers), the method comprising:
determining, for each shipment from a plurality of shipments, a respective sorting destination from a plurality of sorting destinations;
assigning, to each of the shipments from the plurality of shipments, a respective sorting destination-specific input number;
wherein the method furthermore comprises for at least one sorting destination of the plurality of sorting destinations:
arranging those shipments for which the sorting destination was determined into the sorting destination based on the sorting destination-specific input numbers assigned to these shipments; and
determining, for at least the one sorting destination of the plurality of sorting destinations, a delivery sequence for the shipments arranged in the sorting destination based on shipment information; and
outputting, for at least the one sorting destination of the plurality of sorting destinations, a sequence of the input numbers assigned to these shipments sorted in accordance with the delivery sequence of the shipments arranged in the sorting destination;
or
outputting, for at least the one sorting destination of the plurality of sorting destinations, for each of those shipments for which the sorting destination was determined, the respective assigned input number and respective shipment information, wherein a delivery order for these shipments can be determined based on the pieces of shipment information of the shipments.

The arranging of the shipments into the sorting destination based on the assigned input numbers in particular describes a physical arrangement in a physical sorting destination here.

According to a second exemplary aspect of the invention, a method is disclosed, the method comprising:
receiving a sorted sequence of input numbers, wherein an input number is respectively assigned to one shipment from a plurality of shipments, and wherein the sequence of the input numbers is sorted in accordance with a delivery order of the assigned shipments;
or
receiving, for each shipment from a plurality of shipments, an input number assigned to the respective shipment and respective shipment information, wherein a delivery order for these shipments can be determined based on the pieces of shipment information of the shipments; and
determining a delivery order for the shipments at least based on the pieces of shipment information; and
determining a sequence of the input numbers assigned to these shipments sorted in accordance with the delivery order of the shipments;
and
detecting, by a delivery entity, or outputting, to a delivery entity, the input numbers in the sorted sequence, wherein the plurality of shipments is sorted according to the input numbers and the delivery entity can find, based on an input number, the shipment assigned to the input number within the sorted plurality of shipments.

The methods disclosed according to the first and second aspect of the invention ensure a rapid and reliable delivery process, in particular for shipments which are not sorted according to trip order. The requirement of being able to find the shipments rapidly in the delivery process is achieved here by the introduction of input numbers, the sorting of the shipments according to the input numbers, and output of the sorted sequence of the input numbers. Since the trip order sorting of the shipments, which is complex in comparison to sorting according to input numbers, can be omitted, the sorting process is therefore substantially simplified and accelerated according to the invention, so that smaller dimensions of the corresponding sorting installations become possible with an equal quantity of shipments.

The present application furthermore discloses, for each of the two exemplary aspects of the invention:
A computer program, comprising program instructions which cause a processor to perform and/or control the method according to the respective aspect of the invention when the computer program runs on the processor. A processor is to be understood in this specification, among other things, as control units, microprocessors, micro-control units such as microcontrollers, digital signal processors (DSP), application-specific integrated circuits (ASICs), or field-programmable gate arrays (FPGAs). In this case, either all steps of the method can be controlled, or all steps of the method can be performed, or one or more steps can be controlled and one or more steps can be performed. The computer program can be able to be distributed, for example, via a network such as the Internet, a telephone or mobile wireless network, and/or a local network. The computer program can be at least partially software and/or firmware of a processor. It can similarly be at least partially implemented as hardware. The computer program can be, for example, stored on a computer-readable storage medium, e.g., a magnetic, electrical, optical, and/or other type of storage medium. The storage medium can be, for example, part of the processor, for example, a (nonvolatile or volatile) program memory of the processor or a part thereof. The storage medium can be, for example, a concrete or physical storage medium.
A apparatus or a system comprising at least two apparatuses, wherein the apparatus or the system is configured to perform and/or control the method according to the respective aspect of the invention or comprising respective means for performing and/or controlling the steps of the method according to the respective aspect of the invention. In this case, either all steps of the method can be controlled, or all steps of the method can be performed, or one or more steps can be controlled and one or more steps can be performed. One or more of the means can also be performed and/or controlled by the same unit. For example, one or more of the means can be formed by one or more processors.
A apparatus, which comprises at least one processor and at least one memory containing program code, wherein the memory and the program code are configured to cause a apparatus having the at least one processor to perform and/or control at least the method according to the respective aspect of the invention. In this case, either all steps of the method can be controlled, or all steps of the method can be performed, or one or more steps can be controlled and one or more steps can be performed.

Further advantageous exemplary configurations of the invention can be inferred from the following detailed description of several exemplary embodiments of the present invention, in particular in conjunction with the figures. The figures appended to the application are only to be used for the purposes of illustration, however, but not to define the scope of protection of the invention. The appended drawings are not necessarily to scale and are solely to reflect the general concept of the invention by way of example. In particular, features which are contained in the figures are in no way to be viewed as a necessary component of the present invention.

### BRIEF DESCRIPTION OF THE DRAWINGS

In the figures:

FIG. 1 shows a schematic representation of an exemplary embodiment of a system according to the first aspect of the present invention;

FIG. 2 shows a schematic representation of an exemplary embodiment of a system according to the present invention;

FIG. 3 shows a flow chart of an exemplary embodiment of a method according to the first aspect of the present invention; and

FIG. 4 shows a flow chart of an exemplary embodiment of a method according to the second aspect of the present invention.

### DETAILED DESCRIPTION OF SEVERAL EXEMPLARY EMBODIMENTS OF THE INVENTION

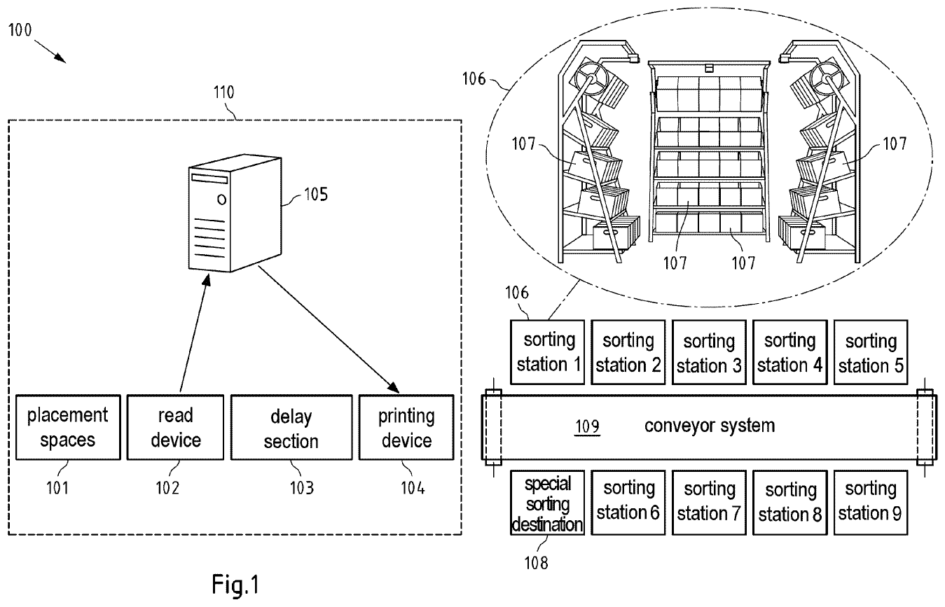

FIG. 1 schematically shows a sorting installation 100, using which an exemplary method according to the first aspect of the present invention for sorting a plurality of shipments can be performed.

In one or more apparatuses, for example, the detection unit 110 consisting of multiple apparatuses, a respective sorting destination from a plurality of sorting destinations is determined for each of the shipments from the plurality of shipments. This can be based, for example, at least on the respective destination address of the shipments. For this purpose, in exemplary embodiments of the invention, a respective destination address is determined for each of the shipments from the plurality of shipments.

A sorting destination is, for example, a specific container 107 in a specific sorting station 106. The sorting installation 100 contains, for example, ten sorting stations 106, which each contain, for example, a specific number of containers 107. A sorting destination can then be defined, for example, by the assignment of a sorting station 106 and the assignment of a container 107 within the sorting station 106, thus, for example, sorting station 1, container 10, or sorting station 2, container 10. Alternatively, for example, the containers 107 can be progressively identifiable over all sorting stations 106 of the sorting installation 100, for example, progressively numbered.

In exemplary embodiments of the invention, one or more delivery tours can be assigned to each sorting destination from the plurality of sorting destinations. The determination of the sorting destination can then be based on a determination of the delivery tour which contains the respective destination address. A delivery tour corresponds here to a set of destination addresses, which are preferably all served by the same delivery entity. A delivery entity can be a person, for example, a deliverer (in particular employed with the delivery company), or a apparatus, e.g., a vehicle, a robot, or a drone, to mention only a few examples.

In some of these exemplary embodiments, precisely one delivery tour is advantageously assigned to each sorting destination from the plurality of sorting destinations. If a container 107 is assigned to precisely one delivery tour of a delivery entity, for example, the container 107 can be transferred to the delivery entity and can be used by this entity on their delivery tour to transport the shipments, without the shipments having to be processed again in the container. In exemplary embodiments, precisely one sorting destination is advantageously assigned to a delivery tour, so that the sorting destination is determined by the determination of the delivery route. For example, if the capacities of the container 107, which is assigned to precisely one delivery tour, are not sufficient for all shipments on this delivery tour, it can be necessary, for example, for multiple containers 107 to be assigned to the same delivery tour and the determination of the sorting destination to additionally be based on further criteria, for example, the location of the destination address within the trip order (trip order number), wherein the trip order describes the order of all destination addresses contained in a delivery tour, in which these are ordered according to the order in which the delivery entity serves these destination addresses.

The detection unit 110 comprises, in the illustrated exemplary embodiment, one or more placement spaces 101, a read apparatus 102, a delay section 103, a printing apparatus 104, and a data processing unit 105.

Individual shipments are supplied to the read apparatus 102, preferably successively. For this purpose, one or more placement spaces 101 are present in front of the read apparatus 102 in the illustrated exemplary embodiment, on which the shipments are placed manually and/or automatically in the sorting installation 100. The read apparatus 102 determines data for each shipment, using which the pieces of information necessary for determining the sorting destination are determined in the data processing unit 105, and transmits these data to the data processing unit 105. The required pieces of information are, for example, pieces of address information, which can be detected, for example, by optical character recognition (OCR), in which images of the shipment are recorded, for example, by a video scanner of the read apparatus 102, which images are subsequently evaluated, for example, on the basis of an address database. Alternatively or additionally, the shipment can already have been provided with a unique shipment identification, for example, upon the submission of the shipment or upon the processing in another distribution center before the transport into the distribution center in which the sorting installation 100 is located. For example, the shipment identification is a barcode, a data matrix code (DMC), a quick response (QR) code, information in plain text, or a radio-frequency identification (RFID) transponder, to mention only a few examples. This shipment identification can be read using the read apparatus 102, for example, using a scanner or an RFID read unit, and linked in the data processing unit 105 with the required pieces of information by a comparison to the data stored in the system. For the processing of shipments with and without shipment identification, the read apparatus 102 is preferably configured to perform multiple different methods for detecting the data.

Subsequently, the shipment is transported in the exemplary embodiment of the invention shown in a delay section 103, while the data processing unit 105 determines the sorting destination for the shipment on the basis of the pieces of information obtained with the aid of the read apparatus 102. For example, the associated delivery tour, in which the destination address is contained, is determined on the basis of the obtained destination address. Each delivery tour is then assigned, for example, precisely one sorting destination. The number of the delivery tours and/or sorting destinations, the assignment of addresses to delivery tours or sorting destinations, and/or the trip order can be defined for a specific period of time; however, for example, it can also be redefined daily or for each sorting procedure, for example, on the basis of changing service plans or shipment amounts.

After the determination of the sorting destination, for example, in the data processing unit 105, a respective sorting destination-specific input number is assigned to each of the shipments from the plurality of shipments. An input number is sorting destination-specific if the input number is unique for all shipments of a sorting destination in each case (for example, at least within a predefined period of time, for example, within a day, or with respect to a sorting run), so that for each sorting destination, each determined input number can be uniquely assigned to one shipment from all shipments determined for the respective sorting destination (for example, within the predefined period of time or for this sorting run).

In exemplary embodiments of the invention, the respective input number of a shipment corresponds to a number of shipments for which the sorting destination determined for this shipment has likewise been determined upon the assignment of the input number, or is related to this number. If, for example, the shipment is the first shipment which was detected for its sorting destination (for example, within the predefined period of time or for one sorting run), the input number 1 is assigned thereto. If three shipments have previously (for example, within the predefined period of time or in this sorting run) been detected for the same sorting destination, the shipment is thus the fourth shipment detected for the sorting destination, the shipment is assigned the input number 4.

In exemplary embodiments of the invention, the shipment is associated with information, wherein at least the input number of the shipment is determinable based on the information. For example, the information is a barcode, a data matrix code (DMC), a QR code, information in plain text, or data in an RFID transponder, to mention only a few examples. In exemplary embodiments, the association of the shipment with the information preferably takes place by applying a label. In these exemplary embodiments, the method furthermore comprises creating a label for the respective shipment. For this purpose, the detection unit 110 additionally comprises, for example, a printing apparatus 104. In alternative embodiments, the information can be printed directly on the shipment or stored in an RFID transponder, for example.

In exemplary embodiments, the shipments are conveyed to their respective sorting destination in the case of a successful determination of the sorting destination. This takes place, for example, in a manual and/or automated manner. In the illustrated exemplary embodiment of the invention, the shipment is initially transported in an automated manner via a conveyor system 109 to a sorting station 106. The shipment is sorted there by a sorting entity, for example, a person (manual) or a apparatus (automatic) into the container 107 which corresponds to the sorting destination determined for the shipment.

In exemplary embodiments of the invention, further pieces of information of the shipment are determinable based on the information associated with the shipment. These pieces of information can be used, for example, for the transport of the shipment to the sorting destination. In exemplary embodiments, at least a part of the associated information is machine-readable, for example, by a QR code, a DMC, or a barcode. In some of these exemplary embodiments, the conveyance of the shipment to the respective determined sorting destination is at least based on the machine-readable part of the information. For example, the sorting station 106 at which the sorting destination is located can be coded in a machine-readable manner on the shipment and can be read by the conveyor system 109 for the conveyance, for example, by one or more scanners. Alternatively or additionally, in some of the exemplary embodiments of the invention, at least a part of the associated information is human-readable. In some of these exemplary embodiments, the conveyance of the shipment to the respective determined sorting destination takes place in the respective sorting destination at least partially manually and based at least on the human-readable part of the information. For example, it can be determined from the information where the sorting destination, the container 107, is located within the sorting station 106, for example, by a letter-number combination which indicates the horizontal and vertical position of the container 107 within the sorting station 106. It is thus not necessary that the sorting person responsible for the arrangement into the containers 107 knows the individual delivery tours and the assignment of the containers 107 to the delivery tours, and it is possible to use the sorting people flexibly at various sorting stations 106, without them having to be specially trained for this purpose.

In addition to the specification of the sorting destination and the input number, based on the information associated with a shipment, for example, pieces of information on the destination address, the delivery tour, or information about the trip order number can be determined.

If a sorting destination cannot be determined for a shipment, the shipment is transported in exemplary embodiments of the invention to a defined special sorting destination 108. The shipment can be manually processed there, for example. The manual processing can comprise, for example, a manual determination of the sorting destination and/or a manual association with the input number. In alternative embodiments, the shipment can be supplied to the detection unit 110 again, for example.

At the sorting destination determined for the shipment, the shipment is arranged into the sorting destination based on the sorting destination-specific input number assigned thereto. In exemplary embodiments of the invention, the arrangement of the shipments takes place in an at least partially automated manner and takes place at least based on the human-readable part of the pieces of information. In exemplary embodiments of the invention, the arrangement of the shipments takes place at least partially manually and takes place at least based on the human-readable part of the pieces of information. The arrangement (for example, physical sorting) of the shipments into a sorting destination takes place, for example, according to rising or falling input number. If the input number of a shipment corresponds to the number of shipments for which the sorting destination determined for this shipment has also been determined upon the assignment of the input number, as described above for exemplary embodiments, the ordering according to rising input numbers can be achieved, for example, in that these are transported according to input sequence to the sorting destination and a shipment is placed in a manual or automated manner there on the already present shipments.

The methods according to the present invention comprise, for a plurality of shipments, determining a delivery order and determining or outputting the sequence of the input numbers assigned to these shipments, which are sorted according to the delivery order.

In a first alternative, these steps are part of the method according to the first aspect of the invention. For this purpose, the method according to the first aspect of the invention, for at least the one sorting destination of the plurality of sorting destinations, comprises determining a delivery order for the shipments arranged into the sorting destination based on shipment information and outputting the sequence of input numbers assigned to these shipments, which is sorted according to the delivery order of the shipments arranged into the sorting destination.

Correspondingly, the method according to the second aspect of the invention comprises, in the first alternative, receiving a sorted sequence of input numbers, wherein an input number is assigned in each case to one shipment from a plurality of shipments, and wherein the sequence of the input numbers is sorted in accordance with a delivery order of the assigned shipments.

The determination of the delivery order can take place, for example, in an external server, which is available, for example, centrally for multiple distribution centers or locally for individual local shipment distribution locations, such as delivery bases or depots. Alternatively, the determination of the delivery order can take place, for example, in the data processing unit 105. The output of the sequence of the input numbers can take place according to the first aspect of the invention, for example, in analog form, for example, by a printed list or a barcode, which is transferred, for example, together with the container 106 and the shipments contained therein to the delivery entity. In exemplary embodiments of the invention, the sequence is output to a mobile apparatus, for example, a mobile telephone or a portable apparatus of the delivery entity (a so-called hand scanner). This takes place, for example, by way of a data transmission via a data communication connection and can also take place, for example, by forwarding via further apparatuses. The data communication with the mobile apparatus is based, for example, on the Internet protocol (IP), wherein the mobile apparatus accesses the Internet, for example, via a wireless radio connection, for example, a cellular mobile wireless connection or a wireless local area network (WLAN). Alternatively, for example, the barcode can be scanned by the mobile apparatus and the input number sequence can thus be detected by the apparatus.

In a second alternative, the above-described steps for determining the delivery order and sequence of the input numbers are part of the method according to the second aspect of the invention. For this purpose, the method according to the first aspect of the invention comprises outputting, for at least one sorting destination of the plurality of sorting destinations, for each of those shipments for which the sorting destination was determined, the respective assigned input number and respective shipment information, wherein a delivery order for these shipments can be determined based on the pieces of shipment information of the shipments. Correspondingly, the method according to the second aspect of the invention comprises receiving, for each shipment from a plurality of shipments, a respective input number assigned to the shipment and respective shipment information, wherein a delivery order can be determined for these shipments based on the pieces of shipment information, and determining the delivery order for the shipments, at least based on the pieces of shipment information, and determining the sequence of the input numbers assigned to these shipments sorted according to the delivery order of the shipments. The transfer of the pieces of shipment information and input numbers can take place here, for example, in the same way as the transfer of the sequence of the input numbers.

The output of the assigned input number and respective shipment information according to the first aspect of the invention can take place, for example, in an analog manner, for example, by a printed list or a barcode, which is transferred to the delivery entity (for example, transported there), for example, together with the container 106 and the shipments contained therein. Alternatively, the output can take place digitally, for example, via a data communication connection to an external server. In exemplary embodiments of the invention, the output takes place to a mobile apparatus, for example, a mobile telephone or a portable apparatus of the delivery entity (a so-called hand scanner). This takes place, for example, by a data transmission via a data communication connection, for example, between the data processing unit 105 and the mobile apparatus, and can also take place, for example, by forwarding via further apparatuses. The data communication with the mobile apparatus is based, for example, on the Internet protocol (IP), wherein the mobile apparatus accesses the Internet, for example, via a wireless radio connection, for example, a cellular mobile wireless connection or a wireless local area network (WLAN). Alternatively, for example, the barcode can be scanned by the mobile apparatus and the input number sequence can thus be detected by the apparatus.

The determination of the delivery order and the sequence of the input numbers can be performed, for example, by the mobile apparatus or by an external server (with which the mobile apparatus communicates in this regard, for example), which is available, for example, for the respective local shipment distribution location (for example, delivery base or depot). The shipment information can contain, for example, the destination addresses of the shipments, on the basis of which the delivery order of the shipments and, accompanying this, the sequence of the input numbers can be determined with knowledge of the trip order of the delivery tour. The trip order of the delivery tour has been stored, for example, in the server or the mobile apparatus at an earlier time or transmitted thereto for the determination. Alternatively, the determination can also be performed, for example, by the delivery entity itself.

In exemplary embodiments of the invention, the shipment information contains at least the respective destination address of the shipment and the determination of the delivery order of the shipments is based at least on the trip order of the delivery tours which comprise the destination addresses.

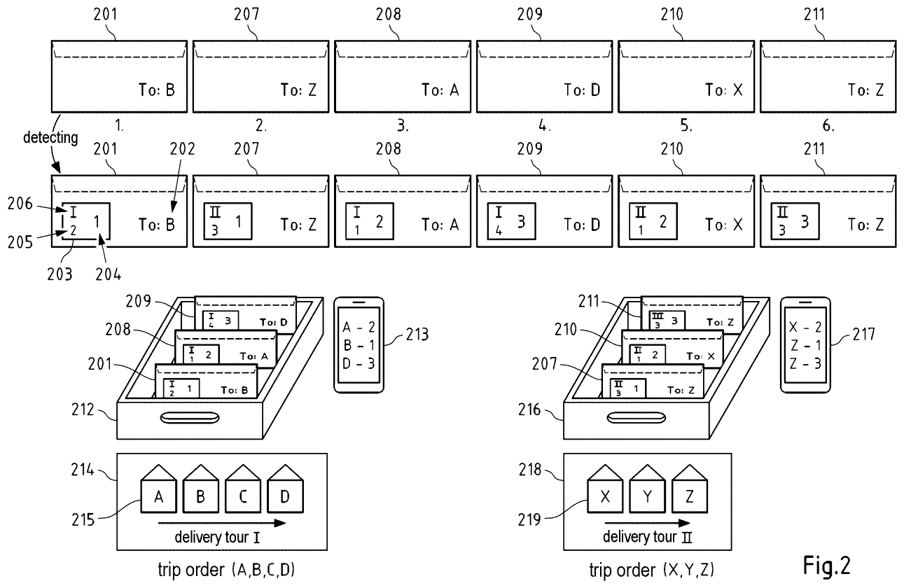

FIG. 2 shows a schematic representation of an exemplary embodiment of the method for six incoming shipments in the distribution center, which are assigned to two different delivery tours 214 and 218. The input number of a shipment corresponds in the illustrated exemplary embodiment to the number of shipments, for which the sorting destination determined for this shipment has also already been determined upon assignment of the input number.

Delivery tour I 214 contains four addresses 215 “A”, “B”, “C”, and “D”, wherein the delivery entity first serves address “A” on their delivery tour, then “B”, then “C”, and finally “D”. The trip order (A, B, C, D) results therefrom for delivery tour I 214. Delivery tour II 218 contains three addresses 219 “X”, “Y”, “Z” with the trip order (X, Y, Z). Each delivery tour I, II is assigned precisely one container 212, 216 as a sorting destination in the distribution center.

The shipment 201 having the destination address “B” 202 is detected in the distribution center as the first shipment. Since this is the first shipment for which the associated delivery tour I 214 and therefore the container 212 was determined as the sorting destination, the shipment 201 is assigned the input number 1. The shipment 201 is identified by this input number in that a corresponding label 203 is prepared and applied to the shipment 201. The label 203 can contain, in addition to the input number “1” 204, for example, a specification of the associated delivery tour “I” 206 and/or the trip order number “2” 205 of the destination address. The destination address “B” 202 has the trip order number 2, since the address “B” is the second address which is served on the associated delivery tour I 214. The shipment is then arranged into the sorting destination, the container 212.

The second detected shipment 207 has the destination address “Z”, which is contained in the delivery tour II 218. Container 216 is therefore determined for the shipment as the sorting destination. Since no other shipment has yet been detected for this sorting destination, the second shipment is also assigned the input number “1”. A corresponding label is then applied and the shipment is arranged into the sorting destination, the container 216.

The third detected shipment 208 has the destination address “A”, which is contained in the delivery tour I 214. Container 212 is therefore determined for the shipment as the sorting destination. Since the shipment 201 was already detected for the container 212, the new shipment 208 is assigned the input number 2 and a corresponding label is applied. The shipment 208 is arranged into the container 210 based on its input number. In the illustrated exemplary embodiment, the shipments of are arranged with rising input numbers into the containers 212, 216. Therefore, the shipment 208 having the input number 2 is arranged behind the first shipment 201 having the input number 1.

The method is also used accordingly with the subsequently detected shipments 209, 210, and 211, so that after arrangement of all shipments from front to rear or viewed in perspective from bottom to top, the shipments 201, 208, and 209 are located in container 212, the destination addresses of which are contained in the delivery tour I 214, and the shipments 207, 210, and 211 are located in container 216, the destination addresses of which are contained in the delivery tour II 218.

For the determination of the delivery order, for example, the trip order of the respective delivery tour is used. For the three shipments 201, 208, and 209 in container 212, initially the shipment 208 having the destination address “A” is delivered, then the shipment 201 having the destination address “B”, and then the shipment 209 having the destination address “D”. The sequence 213 (2, 1, 3) of the input numbers results therefrom. For the three shipments 207, 210, and 211 in container 216, initially the shipment 210 having the destination address “X” is delivered, then the two shipments 207 and 211 having the destination address “Z”. The sequence 217 (2, 1, 3) or (2, 3, 1) of the input numbers results therefrom, from which a sequence can be selected arbitrarily, since both shipments having destination address “Z” are delivered simultaneously.

According to the second aspect of the invention, the sorted sequence of input numbers 213 is received or determined, for example, by the delivery entity of the delivery tour I or a mobile apparatus of the delivery entity, wherein an input number is assigned in each case to one shipment from a plurality of shipments, and wherein the sequence of the input numbers is sorted in accordance with a delivery order of the assigned shipments. The input numbers are detected in the sorted sequence 213 by the delivery entity or output to the delivery entity. The plurality of shipments (for example, in the container 212) is sorted according to the input numbers and the delivery entity can find the shipment assigned to the input number within the plurality of shipments (for example, in the container 212) based on an input number. If the sequence is received or determined, for example, by a mobile apparatus and the input numbers are output by the mobile apparatus to the delivery entity, for example, an app, thus a complex program, is executed for this purpose on the mobile apparatus, which was installed on the mobile apparatus at an earlier time, for example.

As soon as the delivery entity in the local shipment distribution location receives the container 212 having the shipments 201, 208, and 209, the delivery entity can start with the delivery tour I 214, since the shipments no longer have to be further processed in the local shipment distribution location. During the delivery, it is sufficient for the delivery entity to know which shipment has to be delivered next. For this purpose, the next shipment, which has not yet been delivered, is output to the delivery entity or the delivery entity detects it in the sequence of the input numbers 213. Since the shipments are sorted in the container 212, in particular based on the input numbers, the delivery entity can estimate the location of the shipments in the container 212 on the basis of the input number and find the shipments. At the beginning of their delivery tour, the delivery entity detects on the basis of the sequence of the input numbers 213 that the first shipment to be delivered has the input number 2. Since a total of three shipments are in the container 212, the delivery entity can estimate that the shipment having the input number 2 will be located in the middle of the container. After the delivery of the shipment 208 having the input number 2, the delivery entity detects that the next shipment to be delivered has the input number 1, thus in the present case of the shipments sorted in rising order is located at the very front in the container. The delivery time of a shipment is reduced in comparison to an unsorted container by the possibility of estimating the location of the shipment to be delivered in the container 212. In exemplary embodiments of the invention, in which the shipments are associated with information, based on which the input number is determinable, the delivery entity can identify the shipments on the basis of the input number without having to detect further pieces of information, such as the destination address or the addressees, so that the delivery time of a shipment is further reduced.

In exemplary embodiments of the present invention, pieces of shipment-related information are obtained for at least a part of the plurality of shipments together with the input number and subsequently detected or output together with the input numbers. For example, the associated destination address is detected or output for each input number, so that the delivery entity knows to which address the next shipment is to be delivered before they take the shipment from the container. By receiving the destination addresses assigned to the input numbers, the sequence of the input numbers can be unified with other sequences of shipments, which can also be identified on the basis of the destination address, to form one list. For example, the delivery entity additionally has a sequence having packages or shipments to be delivered which require special treatment, for example, a registered letter, for which a signature is required, or collect on delivery, in which a payment process is necessary. Due to the unification of the lists, the delivery process of the delivery entity is simplified for the entirety of their shipments, since the delivery entity does not have to consider different lists or information sources simultaneously.

In exemplary embodiments of the present invention, only a part of the input numbers of all input numbers contained in the sorted sequence of input numbers is output in each case. For this purpose, it is furthermore determined which part of the input numbers of all input numbers contained in the input number sequence is output. For example, only a specific number of the next input numbers is output on the mobile apparatus of the delivery entity, for example, in each case only the input number of the shipment to be delivered next, in order to increase the clarity. In some of these exemplary embodiments, the determination of which part of the input numbers is output is based on the destination addresses of the assigned shipments and the current position of the delivery entity. For example, only the input numbers are displayed which are located on the delivery tour of the delivery entity within a defined distance to their current position. The position of the delivery entity can be determined, for example, by a global positioning system (GPS) receiver in the mobile apparatus and processed therein together with the pieces of information about the delivery tour.

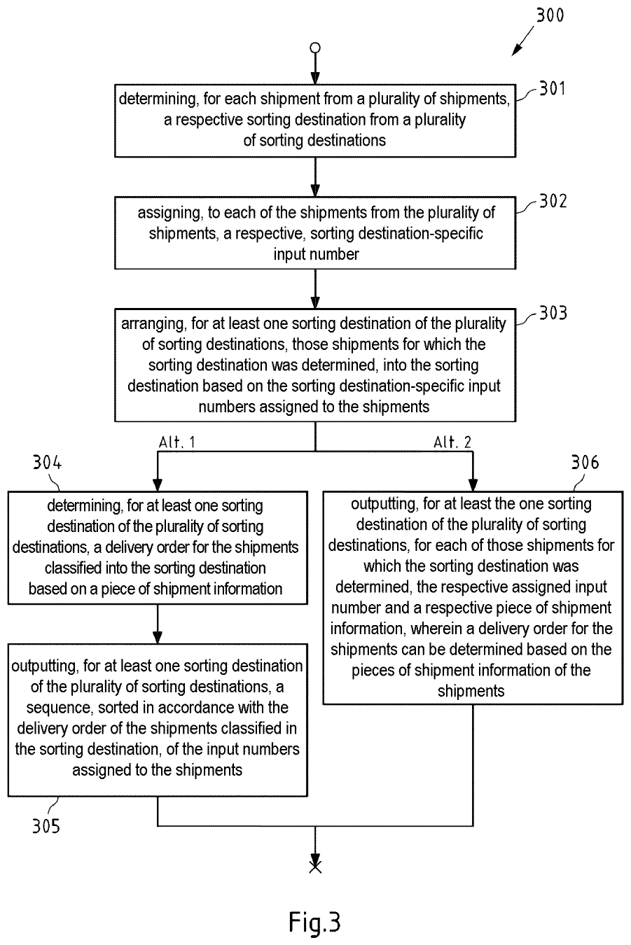

FIG. 3 shows a flow chart 300 of an exemplary embodiment of a method according to the first aspect of the present invention, for example, performed and/or controlled by a sorting installation 100 for sorting a plurality of shipments. This exemplary embodiment of the method is a generalized version of the exemplary embodiments according to the first aspect of the present invention already described on the basis of FIG. 1 and FIG. 2 and can be combined with one or more or all of the features described in these exemplary embodiments.

In step 301, a respective sorting destination from a plurality of sorting destinations is determined for each shipment from a plurality of shipments. In step 302, a respective, sorting destination-specific input number is assigned to each of the shipments from the number of the shipments. The input number of a shipment is sorting destination-specific, if no other shipment is assigned the same input number for the sorting destination of this shipment. A sorting destination-specific input number can thus be uniquely assigned one shipment from all shipments determined for the respective sorting destination. In step 303, for at least one sorting destination of the plurality of sorting destinations, those shipments for which the sorting destination was determined are arranged into the sorting destination based on the sorting destination-specific input numbers assigned to these shipments. The arrangement of a shipment can take place, for example, following the assignment of the sorting destination-specific input number to the shipment, without all shipments for the sorting destination already having been determined. For example, the shipment which was first assigned a sorting destination-specific input number is also first arranged into the sorting destination. Alternatively, for example, all shipments for the sorting destination can be determined first and arranged therein in a common step. In step 304, for at least the one sorting destination of the plurality of sorting destinations, a delivery order for the shipments arranged into the sorting destination is determined based on shipment information. In step 305, for at least the one sorting destination of the plurality of sorting destinations, a sequence of the input numbers assigned to these shipments, sorted according to the delivery order of the shipments arranged into the sorting destination, is output. In step 306, which is an alternative to steps 304 and 305, for at least the one sorting destination of the plurality of sorting destinations, for each of those shipments for which the sorting destination was determined, the respective assigned input number and respective shipment information are output, wherein a delivery order for these shipments can be determined based on the pieces of shipment information of the shipments. Steps 304 and 305 or step 306 can take place before, during, or after the arrangement of the shipments into the sorting destination (step 303).

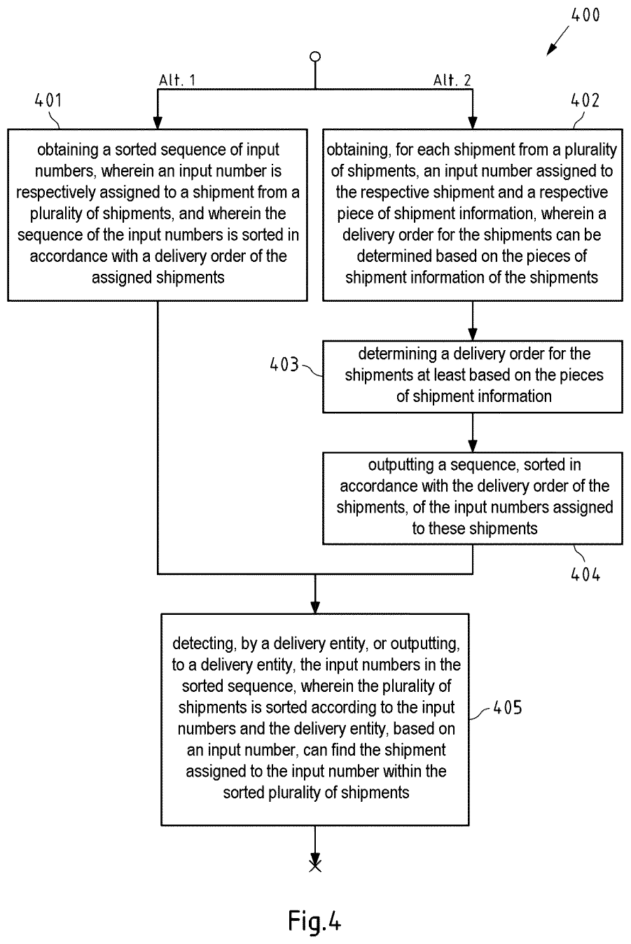

FIG. 4 shows a flow chart 400 of an exemplary embodiment of a method according to the second aspect of the present invention, for example, performed by a delivery entity or a mobile apparatus of a delivery entity. This exemplary embodiment of the method is a generalized version of the exemplary embodiments according to the second aspect of the present invention already described on the basis of FIG. 1 and FIG. 2 and can be combined with one or more or all of the features described in these exemplary embodiments.

In step 401, a sorted sequence of input numbers is received, wherein an input number is respectively assigned to one shipment from a plurality of shipments, and wherein the sequence of the input numbers is sorted in accordance with a delivery order of the assigned shipments. Receiving the sequence corresponds to outputting the sequence in step 305 of the flow chart 300; however, the sequence in step 401 does not necessarily have to be received from a apparatus which performs the method according to step 305. Likewise, the sequence in step 305 does not necessarily have to be output to a apparatus, a person, or a system which/who performs the method according to step 401.

Steps 402, 403, and 404 are alternative to step 401. In step 402, for each shipment from a plurality of shipments, an input number assigned to the respective shipment and respective shipment information are received, wherein a delivery order can be determined based on the pieces of shipment information of the shipments. Receiving the input numbers and pieces of shipment information corresponds to outputting these in step 306 of the flow chart 300; however, the input numbers and pieces of shipment information in step 402 do not necessarily have to be received from a apparatus or a system which performs the method according to step 306. Likewise, the input numbers and pieces of shipment information in step 306 do not necessarily have to be output to a apparatus, a person, or a system, which/who performs the method according to step 402. In step 403, a delivery order, at least based on the pieces of shipment information, is determined for the shipments. In step 404, a sequence, sorted according to the delivery order of the shipments, of the input numbers assigned to these shipments is determined.

In step 405, which both alternatives share, the input numbers are detected in the sorted sequence by a delivery entity or output to a delivery entity, wherein the plurality of shipments is sorted according to the input numbers and the delivery entity can find, based on an input number, the shipment assigned to the input number within the plurality of shipments. If the sequence of the input numbers is received, for example, by a mobile apparatus of the delivery entity in step 401 or determined in step 404, step 405 comprises the output of the input numbers in the sorted sequence to the delivery entity. The output can take place, for example, optically through a display screen of the mobile apparatus and/or acoustically. All input numbers can be output here simultaneously or individually and/or in groups.

A method according to the present invention comprises either the steps of the first alternative or the steps of the second alternative. A apparatus or a system is likewise an apparatus or a system according to the present invention if it is configured for this purpose or comprises means for performing a method having steps of only one or both alternatives.

The exemplary embodiments of the present invention described in this specification are also to be understood as disclosed in all combinations with one another. In particular, the description of a feature comprised by one embodiment-if not explicitly explained otherwise-in the present case is also not to be understood to mean that the feature is indispensable or essential for the function of the exemplary embodiment. The sequence of the method steps described in this specification in the individual flow charts is not compulsory; alternative sequences of the method steps are conceivable. The method steps can be implemented in various ways; an implementation in software (by program instructions), hardware, or a combination of both for implementing the method steps is thus conceivable. Terms used in the claims such as “comprise”, “have”, “contain”, “include”, and the like do not exclude further elements or steps. The wording “at least partially” includes both the case “partially” and the case “completely”. The wording “and/or” is to be understood to mean that both the alternative and the combination are to be disclosed, thus “A and/or B” means “(A) or (B) or (A and B)”. A plurality of units, persons, or the like in the context of this specification means multiple units, persons, or the like. The use of the indefinite article does not exclude a plurality. A single apparatus can perform the functions of multiple units or apparatuses mentioned in the claims. Reference signs indicated in the claims are not to be viewed as restrictions of the means and steps used. All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context

1. A method comprising:
determining, for each shipment from a plurality of shipments, a respective sorting destination from a plurality of sorting destinations;
assigning, to each of the shipments from the plurality of shipments, a respective, sorting destination-specific input number;
wherein the method furthermore comprises, for at least one sorting destination of the plurality of sorting destinations:
arranging those shipments for which the sorting destination was determined into the sorting destination based on the sorting destination-specific input numbers assigned to these shipments;
and
determining a delivery order for the shipments arranged into the sorting destination based on shipment information; and
outputting a sequence, sorted in accordance with the delivery order of the shipments arranged into the sorting destination, of the input numbers assigned to these shipments;
or
outputting, for each of those shipments for which the sorting destination was determined, the respective assigned input number and respective shipment information, wherein a delivery order for these shipments can be determined based on the pieces of shipment information of the shipments.

2. The method according to claim 1, wherein the respective input number of a shipment corresponds to a number of shipments, for which the sorting destination determined for this shipment has likewise been determined upon the assignment of the input number, or is related to this number.

3. The method according to claim 1, furthermore comprising:
conveying the shipments to the respective determined sorting destination.

4. The method according to claim 1, furthermore comprising:
determining, for each of the shipments from the plurality of shipments, a respective destination address, wherein the determining of the respective sorting destination is at least based on the respective destination address.

5. The method according to claim 3, wherein one or more delivery tours are assigned to each sorting destination from the plurality of sorting destinations; and wherein the determining of the respective sorting destination is at least based on the determination of the delivery tour which contains the respective destination address.

6. The method according to claim 5, wherein precisely one delivery tour is assigned to each sorting destination from the plurality of sorting destinations.

7. The method according to claim 5, wherein precisely one sorting destination is assigned to a delivery tour.

8. The method according to claim 1, furthermore comprising:
associating the respective shipment with information, wherein at least the input number is determinable based on the information.

9. The method according to claim 8, wherein the associating of the respective shipment with the information is performed by applying a label to the respective shipment, the method furthermore comprising:
creating the label for the respective shipment.

10. The method according to claim 8, wherein at least a part of the information is machine-readable.

11. The method according to claim 10, provided it refers back directly or indirectly to claim 3, wherein the conveying of the shipment to the respective determined sorting destination is at least based on the machine-readable part of the information.

12. The method according to claim 10, wherein the arranging of the shipments into the respective sorting destination takes place in an at least partially automated manner and is at least based on the machine-readable part of the information.

13. The method according to claim 8, wherein at least a part of the information is human-readable.

14. The method according to claim 13, provided it refers back directly or indirectly to claim 3, wherein the conveying of the shipments to the respective sorting destination is performed at least partially manually and is at least based on the human-readable part of the information.

15. The method according to claim 13, wherein the arranging of the shipments into the respective sorting destination is performed at least partially manually and is at least based on the human-readable part of the information.

16. The method according to claim 1, wherein the outputting takes place to a mobile apparatus.

17. The method according to claim 1, wherein the shipment information contains at least the respective destination address of the shipment, and wherein the determining of the delivery order is at least based on the trip order of the delivery tours that comprise the destination addresses.

18. A method comprising:
obtaining a sorted sequence of input numbers, wherein an input number is respectively assigned to one shipment from a plurality of shipments, and wherein the sequence of the input numbers is sorted according to a delivery order of the assigned shipments;
or
obtaining, for each shipment from a plurality of shipments, an input number assigned to the respective shipment and respective shipment information, wherein based on the pieces of shipment information of the shipments, a delivery order for these shipments can be determined; and
determining a delivery order for the shipments at least based on the pieces of shipment information; and
determining a sequence, sorted according to the delivery order of the shipments, of the input numbers assigned to these shipments;
and
detecting, by a delivery entity, or outputting, to a delivery entity, the input numbers in the sorted sequence, wherein the plurality of shipments is sorted according to the input numbers and the delivery entity can find, based on an input number, the shipment assigned to the input number within the sorted plurality of shipments.

19. The method according to claim 18, wherein, for at least a part of the plurality of shipments, shipment-related pieces of information are received together with the input number, and wherein for the part of the plurality of shipments, the output of the input numbers is performed together with the shipment-related pieces of information.

20. The method according to claim 18, wherein only a part of the input numbers of all input numbers contained in the sorted sequence of input numbers is output, respectively, furthermore comprising:
determining which part of the input numbers of all input numbers contained in the sequence of input numbers is output.

21. The method according to claim 20, wherein the determining which part of the input numbers is output is based on the destination addresses of the assigned shipments and the position of the delivery entity.

22. A method comprising:
obtaining a sorted sequence of input numbers, wherein an input number is respectively assigned to one shipment from a plurality of shipments, and wherein the sequence of the input numbers is sorted according to a delivery order of the assigned shipments;
or
obtaining, for each shipment from a plurality of shipments, an input number assigned to the respective shipment and respective shipment information, wherein based on the pieces of shipment information of the shipments, a delivery order for these shipments can be determined; and
determining a delivery order for the shipments at least based on the pieces of shipment information; and
determining a sequence, sorted according to the delivery order of the shipments, of the input numbers assigned to these shipments; and
detecting, by a delivery entity, or outputting, to a delivery entity, the input numbers in the sorted sequence, wherein the plurality of shipments is sorted according to the input numbers and the delivery entity can find, based on an input number, the shipment assigned to the input number within the sorted plurality of shipments, wherein the input numbers have been assigned to the shipments of the plurality of shipments according to the method according to claim 1.

23. An apparatus or system made up of at least two apparatuses, configured for performing and/or controlling the method according to claim 1.

24. Apparatus, configured for performing and/or controlling the method according to claim 18 or comprising means for performing the method according to claim 18.

25. A computer program, comprising program instructions which cause a processor to perform and/or control the method according to claim 1 when the computer program runs on the processor.

26. A computer program, comprising program instructions which cause a processor to perform and/or control the method according to claim 18 when the computer program runs on the processor.

27. An apparatus or system made up of at least two apparatuses comprising means for performing and/or controlling the steps of the method according to claim 1.
